(19) United States
(12) Patent Application Publication
(10) Pub. No.: US 2010/0045686 A1
(43) Pub. Date: Feb. 25, 2010

(54) Display Method Applied to Electrophoretic Display and Corresponding Electrophoretic Display

(76) Inventors: Hung-Chih HUANG, Hsinchu City (TW); Hsing-Chung Chen, Hsinchu City (TW)

Correspondence Address: HDLS Patent & Trademark Services, P.O. BOX 220746, CHANTILLY, VA, 20153-0746, US

(21) Appl. No.: 12/336,527

(22) Filed: Dec. 16, 2008

(30) Foreign Application Priority Data
Aug. 20, 2008 (TW) 097131801

(51) Int. Cl. G06F 13/00

(52) U.S. Cl. 345/536

(57) ABSTRACT

In a display method applied to an electrophoretic display, the electrophoretic display has a first memory, a second memory and an electrophoretic display panel. A plurality of data is stored in the first memory according to a predetermined sequence. The display method includes the following steps. Firstly, whether a first datum of the data is stored in the second memory is determined. Next, the first datum is read out from the first memory and stored in the second memory if the first datum is not stored in the second memory. Next, the first datum stored in the second memory is displayed on the electrophoretic display panel. Next, a second datum before the first datum and/or a third datum after the first datum are/is read out from the first memory and stored in the second memory during displaying the first datum on the electrophoretic display panel.

### BACKGROUND

1. Field of the Invention

The present invention relates to a display method and an electrophoretic display, and more particularly, to a display method applied to an electrophoretic display and a corresponding electrophoretic display using the display method.

2. Description of the Related Art

FIG. 1 is a schematic view of a conventional electrophoretic display. Referring to FIG. 1, the conventional electrophoretic display 100 includes a nonvolatile memory 110, a volatile memory 120, a processor 130, a timing controller 140 and an electrophoretic display panel 150. A plurality of data is stored in the nonvolatile memory 110.

When a user wants to view a datum of the data on the electrophoretic display panel 150, the processor 130 reads out this datum from the nonvolatile memory 110 and stores this datum in the volatile memory 120 via a bus (not shown) of the timing controller 140 firstly. Then the processor 130 displays this datum stored in the volatile memory 120 on the electrophoretic display panel 150 by means of the timing controller 140. When the user wants to view another datum of the data on the electrophoretic display panel 150, the processor 130 reads out another datum from the nonvolatile memory 110 and displays another datum on the electrophoretic display panel 150 according to the steps mentioned above.

FIG. 2 is schematic cross-sectional view of the electrophoretic display panel of FIG. 1. Referring to FIGS. 1 and 2, the electrophoretic display panel 150 includes an electrophoretic layer 152 having a plurality of microcapsules 152a and electrophoretic fluid 152b filling in each of the microcapsules 152a. The electrophoretic fluid 152b in each of the microcapsules 152a includes a dielectric solvent 152c and a plurality of charged pigment particles 152d dispersed in the dielectric solvent 152c. One side of each of the charged pigment particles 152d is white and another side thereof is black.

When each of the data is displayed on the electrophoretic display panel 150, the charged pigment particles 152d move to a side of the electrophoretic display panel 150 and rotate in various ways to show a corresponding datum. In addition, the dielectric solvent 152c is viscous so as to limit the moving speed of each of the charged pigment particles 152d. Therefore, when each of the data is displayed on the electrophoretic display panel 150, a corresponding response time of the electrophoretic display panel 150 must be spent.

However, when the user wants to view the data in order or in inverse order, the processor 130 must read out the data from the nonvolatile memory 110 in order or in inverse order and display the data on the electrophoretic display panel 150 in order or in inverse order. In specific, when the user transforms viewing a datum into viewing another datum, the user must wait for the time for the processor 130 reading out the nonvolatile memory 110, the time for the processor 130 accessing the volatile memory 120 and the response time of the electrophoretic display panel 150. Therefore, the overall time for displaying the data in order or that for displaying the data in inverse order of the conventional electrophoretic display 100 is relatively long.

### BRIEF SUMMARY

The present invention is directed to provide a display method applied to an electrophoretic display such that the overall time for displaying the data in order or that for displaying the data in inverse order of the electrophoretic display is reduced.

The present invention is directed to provide an electrophoretic display of which the overall time for displaying the data in order or that for displaying the data in inverse order is relatively short.

A display method applied to an electrophoretic display in accordance with an embodiment of the present invention is provided. The electrophoretic display has a first memory, a second memory and an electrophoretic display panel. A plurality of data is stored in the first memory according to a predetermined sequence. The display method includes the following steps. First, whether a first datum of the data is stored in the second memory is determined. Next, the first datum is read out from the first memory and then the first datum is stored in the second memory if the first datum is not stored in the second memory. Next, the first datum stored in the second memory is displayed on the electrophoretic display panel. Next, a second datum before the first datum and/or a third datum after the first datum are/is read out from the first memory and then stored in the second memory during displaying the first datum on the electrophoretic display panel.

In an embodiment of the present invention, before the step of displaying the first datum on the electrophoretic display panel, the display method applied to the electrophoretic display further includes the step of not reading out the first datum from the first memory if the first datum is stored in the second memory.

In an embodiment of the present invention, the step of reading out the second datum and/or the third datum from the first memory and storing the second datum and/or the third datum in the second memory comprises the following procedures. Firstly, whether the second datum and/or the third datum are/is stored in the second memory is determined. Next, the second datum is read out from the first memory and then the second datum is stored in the second memory if the second datum is not stored in the second memory. Next, the third datum is read out from the first memory and then the third datum is stored in the second memory if the third datum is not stored in the second memory.

In an embodiment of the present invention, the step of reading out the second datum and/or the third datum from the first memory and storing the second datum and/or the third datum in the second memory is the step of directly reading out the second datum and/or the third datum from the first memory and storing the second datum and/or the third datum in the second memory.

In an embodiment of the present invention, the second datum is a previous one datum before the first datum and the third datum is a following one datum after the first datum.

In an embodiment of the present invention, the accessing speed of the first memory is less than that of the second memory. In addition, the first memory is a nonvolatile memory and the second memory is a volatile memory.

An electrophoretic display in accordance with an embodiment of the present invention is provided. The electrophoretic display comprises a first memory, a second memory, a processor, a timing controller and an electrophoretic display panel. A plurality of data is stored in the first memory according to a predetermined sequence. The processor is electrically coupled to the first memory and the second memory respectively and is adapted to read out the data. The processor determines whether a first datum of the data is stored in the second memory. If the first datum is not stored in the second memory, the processor reads out the first datum from the first memory and stores the first datum in the second memory.

The timing controller is electrically coupled to the second memory. The electrophoretic display panel is electrically coupled to the timing controller. The processor displays the first datum stored in the second memory on the electrophoretic display panel by means of the timing controller. During displaying the first datum on the electrophoretic display panel, the processor reads out a second datum before the first datum and/or a third datum after the first datum from the first memory and stores the second datum and/or the third datum in the second memory.

In an embodiment of the present invention, before displaying the first datum on the electrophoretic display panel, the processor does not read out the first datum from the first memory if the first datum is stored in the second memory.

In an embodiment of the present invention, the way of the processor reading out the second datum and/or the third datum from the first memory and storing the second datum and/or the third datum in the second memory includes the way of the processor determining whether the second datum and/or the third datum are stored in the second memory, the way of the processor reading out the second datum from the first memory and then storing the second datum in the second memory if the second datum is not stored in the second memory and the way of the processor reading out the third datum from the first memory and storing the third datum in the second memory if the third datum is not stored in the second memory.

In an embodiment of the present invention, the way of the processor reading out the second datum and/or the third datum from the first memory and storing the second datum and/or the third datum in the second memory is the way of the processor directly reading out the second datum and/or the third datum from the first memory and storing the second datum and/or the third datum in the second memory.

In an embodiment of the present invention, the second datum is a previous one datum before the first datum and the third datum is a following one datum after the first datum.

In an embodiment of the present invention, the accessing speed of the first memory is less than that of the second memory. In addition, the first memory is a nonvolatile memory and the second memory is a volatile memory.

During displaying the first datum on the electrophoretic display panel, the second datum before the first datum and the third datum after the first datum are stored in the second memory. Therefore, when the user transforms viewing a datum into viewing another datum in order or in inverse order, the user only needs to wait for the time for reading out the datum from the second memory and the response time of the electrophoretic display panel. Thus, compared with the conventional arts, the overall time of the electrophoretic display for displaying the data in order or that of the electrophoretic display for displaying the data in inverse order is reduced through the display method applied to the electrophoretic display of the present embodiment.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic view of a conventional electrophoretic display.

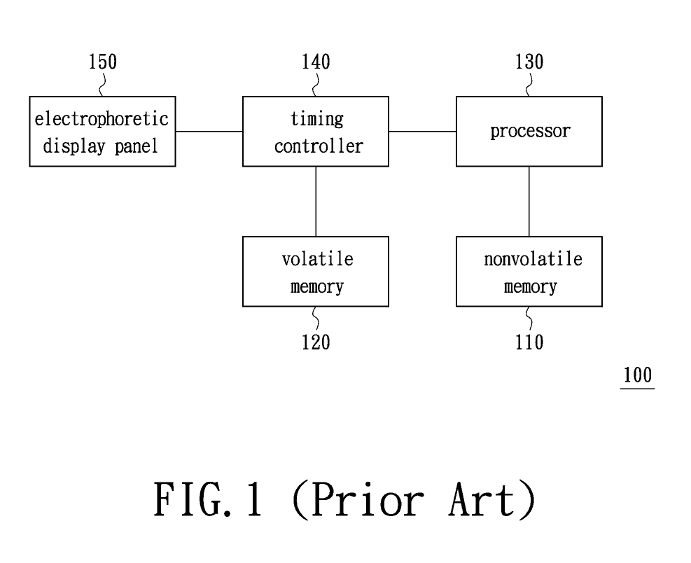

FIG. 2 is a schematic cross-sectional view of the electrophoretic display of FIG. 1.

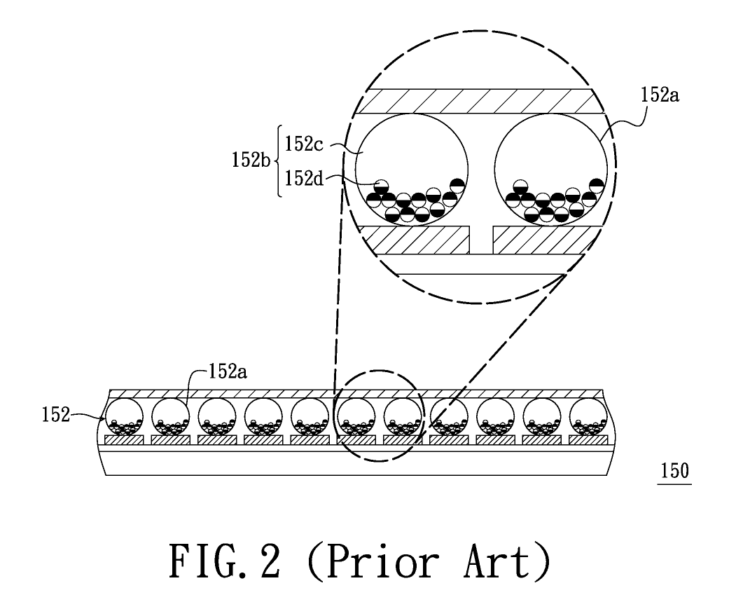

FIG. 3 is a schematic view of an electrophoretic display in accordance with a first embodiment of the present invention.

FIG. 4 is a flow chart of a display method applied to an electrophoretic display in accordance with the first embodiment of the present invention.

FIG. 5 is a detailed flow chart of the step 304 of the display method applied to the electrophoretic display of FIG. 4.

FIG. 6 is a schematic view of an electrophoretic display in accordance with a second embodiment of the present invention.

### DETAILED DESCRIPTION

Reference will now be made to the drawings to describe exemplary embodiments of the present display method, in detail. The following description is given by way of example, and not limitation.

### First Embodiment

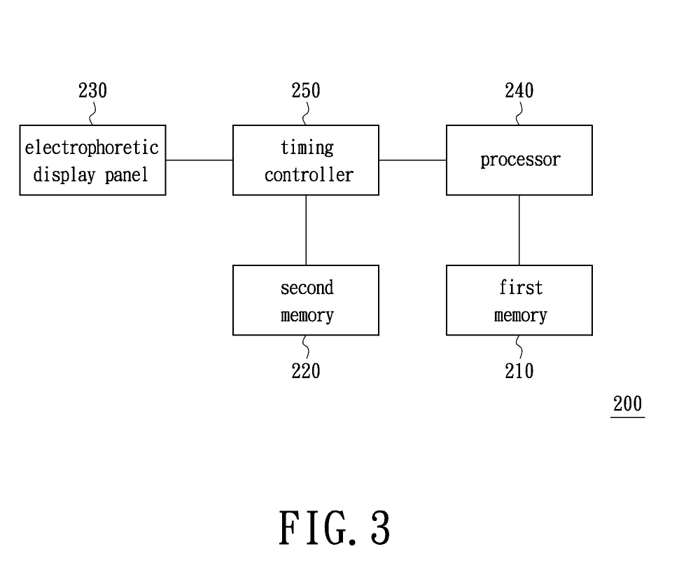

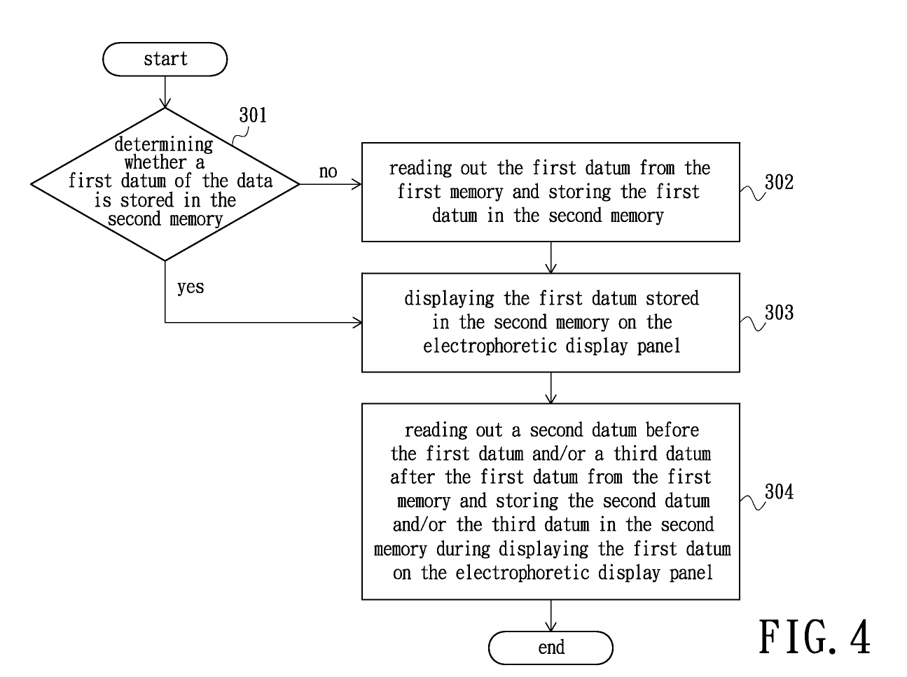

FIG. 3 is a schematic view of an electrophoretic display in accordance with a first embodiment of the present invention. FIG. 4 is a flow chart of a display method applied to the electrophoretic display in accordance with the first embodiment of the present invention. Referring to FIGS. 3 and 4, the electrophoretic display 200 of the present embodiment includes a first memory 210, a second memory 220 and an electrophoretic display panel 230. A plurality of data is stored in the first memory 210.

The display method applied to the electrophoretic display of the present embodiment includes the following steps. Firstly, the step 301 is performed. The step 301 is that whether a first datum of the data is stored in the second memory 220 is determined. Next, if the first datum is not stored in the second memory 220, the step 302 is performed. The step 302 is that the first datum is read out from the first memory 210 and the first datum is stored in the second memory 220. It should be noted that, in the present embodiment, the step 302 is not performed if the first datum is stored in the second memory 220.

Next, the step 303 is performed. The step 303 is that the first datum stored in the second memory 220 is displayed on the electrophoretic display panel 230. Next, the step 304 is performed. The step 304 is that a second datum before the first datum and/or a third datum after the first datum are/is read out from the first memory 210 and stored in the second memory 220 during displaying the first datum on the electrophoretic display panel 230. In the present embodiment, the second datum is a previous one datum before the first datum and the third datum is a following one datum after the first datum. For example, if the data are composed of an electronic book with 100 pages and if the first datum is composed of the first page, the second datum is composed of the 100^{th} page and the third datum is composed of the second page. If the first datum is composed of the second page, the second datum is composed of the first page and the third datum is composed of the third page. The rest of examples may be deduced by analogy.

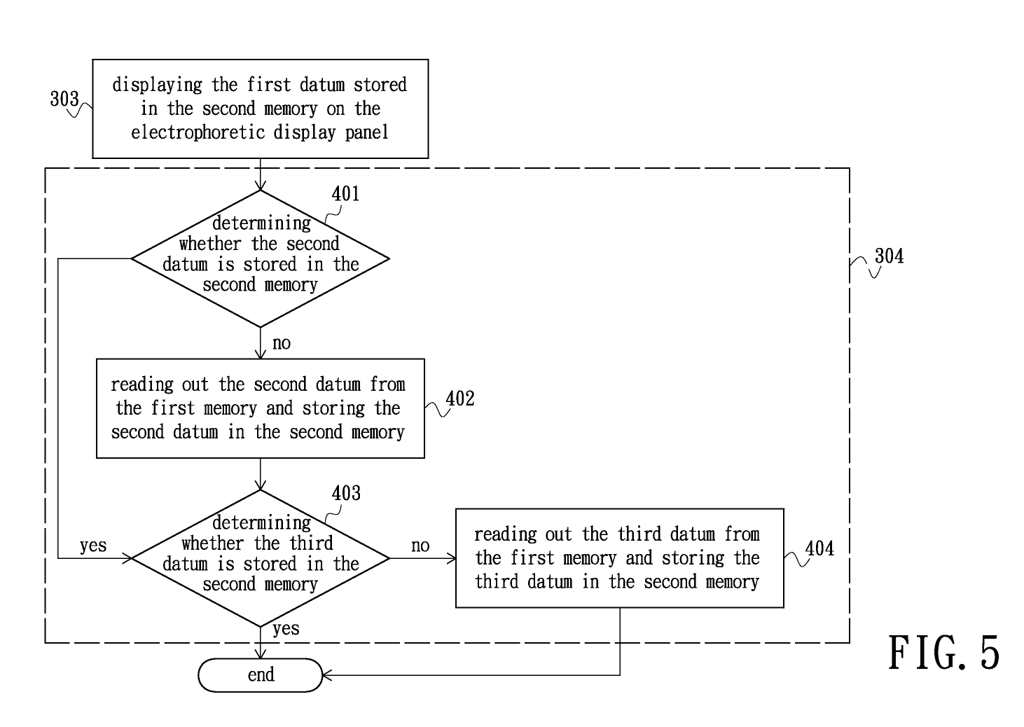

FIG. 5 is a detailed flow chart of the step 304 of the display method applied to the electrophoretic display of FIG. 4. Referring to FIGS. 3, 4 and 5, in the present embodiment, the step 304 of reading out the second datum before the first datum and/or the third datum after the first datum from the first memory 210 and storing the second datum and/or the third datum in the second memory 220 includes the following procedures. Firstly, the procedure 401 is performed. The procedure 401 is that whether the second datum is stored in the second memory 220 is determined. Next, if the second datum is not stored in the second memory 220, the procedure 402 is performed. The procedure 402 is that the second datum is read out from the first memory 210 and the second datum is stored in the second memory 220. Next, the procedure 403 is performed. The procedure 403 is that whether the third datum is stored in the second memory 220 is determined. Next, if the third datum is not stored in the second memory 220, the procedure 404 is performed. The procedure 404 is that the third datum is read out from the first memory 210 and the third datum is stored in the second memory 220.

It should be noted that, in another embodiment, the step 304 of reading out the second datum before the first datum and/or the third datum after the first datum from the first memory 210 and storing the second datum and/or the third datum in the second memory 220 may be amended by a designer according to the designing requirement to be that the second datum and/or the third datum from are/is directly read out the first memory 210 and the second datum and/or the third datum are/is in the second memory 220.

The detailed description of the electrophoretic display 200 using the above display method of the present embodiment is described thereinafter. Referring to FIGS. 3, 4 and 5 again, the electrophoretic display 200 of the present embodiment further includes a processor 240 and a timing controller 250. The processor 240 is electrically coupled to the first memory 210 and the second memory 220 respectively and is adapted to read out the data stored in the first memory 210. The processor 240 is adapted to perform the step 301 for determining whether the first datum of the data is stored in the second memory 220. If the first datum is not stored in the second memory 220, the processor 240 performs the step 302 for reading out the first datum from the first memory 210 and storing the first datum in the second memory 220. In specific, the processor 240 may store the first datum in the second memory 220 by means of a bus (not shown) of the timing controller 250.

It should be noted that, in the present embodiment, the accessing speed of the first memory 210 may be less than that of the second memory 220. In addition, the first memory 210 may be a nonvolatile memory and the second memory 220 may be a volatile memory.

The timing controller 250 is electrically coupled to the second memory 220. The electrophoretic display panel 230 is electrically coupled to the timing controller 250. The processor 240 performs the step 303 for displaying the first datum stored in the second memory 220 on the electrophoretic display panel 230 by means of the timing controller 250. In specific, the processor 240 transmits the first datum stored in the second memory 220 to the timing controller 250 and the timing controller 250 transmits the first datum to the electrophoretic display panel 230 for displaying the first datum. In another embodiment, the timing controller 250 may receive an electrical signal of the processor 240 to directly read out the first datum stored in the second memory 220 and transmit the first datum to the electrophoretic display panel 230. In other words, the transmitting relation between the processor 240 and the timing controller 250 may be amended according to the designer's requirement. This embodiment is described as an example only and is not intended to limit the scope of the present invention.

The processor 240 also performs the step 304 for reading out the second datum before the first datum and/or the third datum after the first datum from the first memory 210 and storing the second datum and/or the third datum in the second memory 220 during displaying the first datum on the electrophoretic display panel 230.

During displaying the first datum on the electrophoretic display panel 230, the second datum before the first datum and the third datum after the first datum are stored in the second memory 220. Therefore, when the user transfers viewing a datum into viewing another datum in order or in inverse order, the user only needs to wait for the time for reading out the datum from the second memory 220 and the response time of the electrophoretic display panel 230. Thus, compared with the conventional arts, the overall time of the electrophoretic display 200 for displaying the data in order or that of the electrophoretic display 200 for displaying the data in inverse order is reduced through the display method applied to the electrophoretic display.

### Second Embodiment

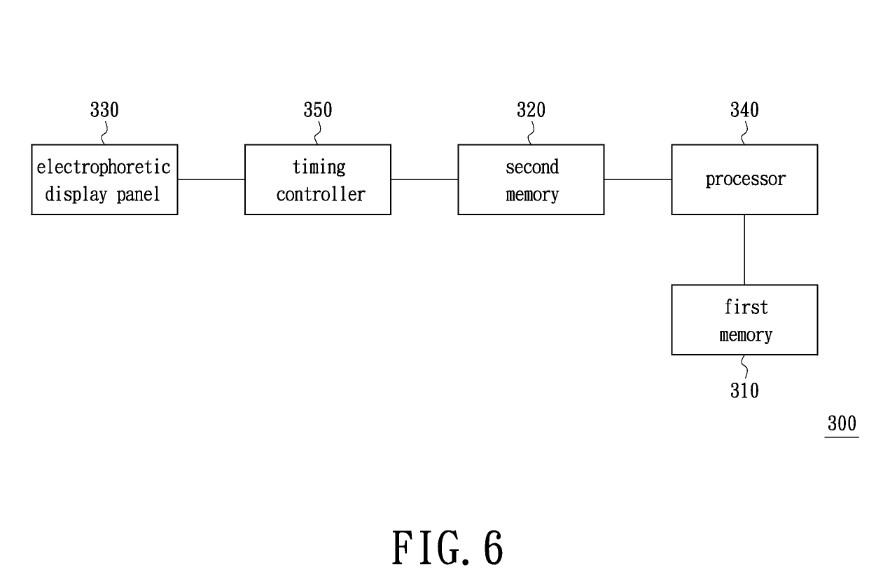

FIG. 6 is a schematic view of an electrophoretic display in accordance with a second embodiment of the present invention. The difference between the electrophoretic display 300 of the present embodiment and the electrophoretic display 200 of the first embodiment lies in that the processor 340 is electrically coupled to the second memory 320 directly and directly stores the first datum in the second memory 320. In addition, the operations of the first memory 310, the second memory 320, the electrophoretic display panel 330, the processor 340 and the timing controller 350 are similar to those of the first memory 210, the second memory 220, the electrophoretic display panel 230, the processor 240 and the timing controller 250 respectively and not described thereinafter.

In summary, the display method applied to the electrophoretic display of the each of the embodiments of the present invention at least includes the following advantages or other advantages. During displaying the first datum on the electrophoretic display panel, the second datum before the first datum and the third datum after the first datum are stored in the second memory. Therefore, when the user transfers viewing a datum into viewing another datum in order or in inverse order, the user only needs to wait for the time for reading out the datum from the second memory and the response time of the electrophoretic display panel. Thus, compared with the conventional arts, the overall time of the electrophoretic display for displaying the data in order or that of the electrophoretic display for displaying the data in inverse order is reduced through the display method applied to the electrophoretic display of the present embodiment.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display method applied to an electrophoretic display, wherein the electrophoretic display has a first memory, a second memory and an electrophoretic display panel, and a plurality of data is stored in the first memory according to a predetermined sequence, the method comprising:
determining whether a first datum of the data is stored in the second memory;
reading out the first datum from the first memory and storing the first datum in the second memory if the first datum is not stored in the second memory;
displaying the first datum stored in the second memory on the electrophoretic display panel; and
reading out a second datum before the first datum and/or a third datum after the first datum from the first memory and storing the second datum and/or the third datum in the second memory during displaying the first datum on the electrophoretic display panel.

2. The display method applied to the electrophoretic display as claimed in claim 1, before the step of displaying the first datum on the electrophoretic display panel, further comprising:
not reading out the first datum from the first memory if the first datum is stored in the second memory.

3. The display method applied to the electrophoretic display as claimed in claim 1, wherein the step of reading out the second datum and/or the third datum from the first memory and storing the second datum and/or the third datum in the second memory comprises:
determining whether the second datum and/or the third datum are/is stored in the second memory;
reading out the second datum from the first memory and storing the second datum in the second memory if the second datum is not stored in the second memory; and
reading out the third datum from the first memory and storing the third datum in the second memory if the third datum is not stored in the second memory.

4. The display method applied to the electrophoretic display as claimed in claim 1, wherein the step of reading out the second datum and/or the third datum from the first memory and storing the second datum and/or the third datum in the second memory is the step of directly reading out the second datum and/or the third datum from the first memory and storing the second datum and/or the third datum in the second memory.

5. The display method applied to the electrophoretic display as claimed in claim 1, wherein the second datum is a previous one datum before the first datum and the third datum is a following one datum after the first datum.

6. The display method applied to the electrophoretic display as claimed in claim 1, wherein an accessing speed of the first memory is less than that of the second memory.

7. The display method applied to the electrophoretic display as claimed in claim 6, wherein the first memory is a nonvolatile memory and the second memory is a volatile memory.

8. An electrophoretic display, comprising:
a first memory, wherein a plurality of data is stored in the first memory according to a predetermined sequence;
a second memory;
a processor electrically coupled to the first memory and the second memory respectively and adapted to read out the data, wherein the processor determines whether a first datum of the data is stored in the second memory and the processor reads out the first datum from the first memory and stores the first datum in the second memory if the first datum is not stored in the second memory;
a timing controller electrically coupled to the second memory; and
an electrophoretic display panel electrically coupled to the timing controller, wherein the processor displays the first datum stored in the second memory on the electrophoretic display panel by means of the timing controller, and during displaying the first datum on the electrophoretic display panel, the processor reads out a second datum before the first datum and/or a third datum after the first datum from the first memory and stores the second datum and/or the third datum in the second memory.

9. The electrophoretic display as claimed in claim 8, wherein before displaying the first datum on the electrophoretic display panel, the processor does not read out the first datum from the first memory if the first datum is stored in the second memory.

10. The electrophoretic display as claimed in claim 8, wherein the way of the processor reading out the second datum and/or the third datum from the first memory and storing the second datum and/or the third datum in the second memory comprises:
processor determining whether the second datum and/or the third datum are/is stored in the second memory;
processor reading out the second datum from the first memory and storing the second datum in the second memory if the second datum is not stored in the second memory; and
processor reading out the third datum from the first memory and storing the third datum in the second memory if the third datum is not stored in the second memory.

11. The electrophoretic display as claimed in claim 8, wherein the way of the processor reading out the second datum and/or the third datum from the first memory and storing the second datum and/or the third datum in the second memory is the way of the processor directly reading out the second datum and/or the third datum from the first memory and storing the second datum and/or the third datum in the second memory.

12. The electrophoretic display as claimed in claim 8, wherein the second datum is a previous one datum before the first datum and the third datum is a following one datum after the first datum.

13. The electrophoretic display as claimed in claim 8, wherein the accessing speed of the first memory is less than that of the second memory.

14. The electrophoretic display as claimed in claim 13, wherein the first memory is a nonvolatile memory and the second memory is a volatile memory.
